(19) United States
(12) Patent Application Publication
(10) Pub. No.: US 2009/0096213 A1
(43) Pub. Date: Apr. 16, 2009

(54) Vertical axis wind turbine and method of making the same

(76) Inventor: Jerry W. Berglund, Placitas, NM (US)

Correspondence Address: The Adams Law Firm, Suite H262, 901 Rio Grande Blvd. NW, Albuquerque, NM, 87104, US

(21) Appl. No.: 12/287,666

(22) Filed: Oct. 10, 2008

Related U.S. Application Data
(60) Provisional application No. 60/979,661, filed on Oct. 12, 2007.

(51) Int. Cl. F03D 9/00; F03D 3/06; F03D 7/06; B21D 5/00

(52) U.S. Cl. 290/44; 416/223 R; 290/55; 416/47; 72/362

(57) ABSTRACT

The present invention includes a vertical axis wind turbine apparatus including a spindle tube connectable to a permanent foundation such that a spindle axis is oriented substantially orthogonal to a surface upon which it is placed, such as the ground or other stable surface. The apparatus described herein also includes a rotor disposed at least partially within the spindle tube and rotationally engaged therewith such that a rotor axis is oriented substantially parallel to the spindle axis. The apparatus can also include a truss system extending radially from the rotor and a blade assembly movably connected to the truss system and adapted for rotation about the spindle axis and the rotor axis. The truss system functions in part to permit rotation of the blade assembly while increasing the swept area of the turbine and thus the resultant energy capture.

### CLAIM OF PRIORITY UNDER 35 U.S.C. §119

The present Application for Patent claims priority to Provisional Application No. 60/979,661 entitled “A Darrieus Type Vertical Axis Wind Turbine and Airfoil Blade Bending Device,” filed Oct. 10, 2007, and is hereby expressly incorporated by reference herein.

### BACKGROUND

1. Field of the Present Invention

The present invention relates generally to the field of energy technology, and more particularly to the field of conversion of wind energy into electricity for commercial and private use.

2. History of the Related Art

For centuries wind energy has been harnessed to perform useful work for mankind. Aside from wind-powered sails used to propel ships, the majority of wind powered devices converted wind energy into mechanical power to grind grain or pump water. During the 1930's wind powered devices were developed to produce electricity for remote applications. However, in the United States, the advent of government funded rural electrification programs that used fossil fuels largely eliminated interest in wind-generated electricity. Not until the world energy crisis in the early 1970's did significant efforts to develop wind energy conversion systems begin. Since 1973 substantial amounts of government and private funds have been invested world wide for the development of wind energy systems.

Historically, and continuing today, most wind turbines designed to produce electricity have been horizontal axis wind turbines (HAWTs) where the axis of rotation of the turbine is normally aligned with the wind direction and parallel to the earth's surface. In the 1920's a new class of wind turbines, called vertical axis wind turbines (VAWTs), began to emerge. The axis of rotation of these VAWTs was perpendicular to the surface of the earth and to the flow of wind. An inventor named Savonius developed a VAWT that operated on aerodynamic drag much like an anemometer. Savonius design turbines suffer from low aerodynamic efficiency and thus have not been largely employed. In 1926 the French inventor Georges J. M. Darrieus designed and patented a VAWT that used aerodynamic lift forces to propel airfoil shaped blades (similar in shape to an airplane wing) around a vertical axis. The Darrieus design used a vertical rotor to which was attached curved blades with aerodynamic shaped cross-sections. The vertical rotor must be sufficiently tall so that the blades are spaced above the ground where wind flow may be erratic and unstable; because of its height the vertical rotor was held erect by guy cables and supported by vertical thrust bearings.

The Darrieus design lay essentially idle until the above-mentioned 1973 world energy crisis when several research organizations began developing and testing larger and more modern versions of the Darrieus turbine. However, most of these VAWTs continued to employ guy cables to hold the turbine spindle in its vertical position thus restricting the swept area and power production, exacerbating vibration problems and increasing bearing loads.

Accordingly, there is a need in the art for a VAWT design and method of making the same that alleviates the need for guy wires that produce high vertical loads on the rotor bearings while the design minimizes any unnecessary forces and bearing loads that destabilize and complicate the structure while maximizing the swept area of the blades.

### SUMMARY OF THE PRESENT INVENTION

Accordingly, the present invention includes a vertical axis wind turbine apparatus including a spindle tube connectable to a permanent foundation such that a spindle axis is oriented substantially orthogonal to a surface upon which it is placed, such as the ground or other stable surface. The apparatus described herein also includes a rotor disposed at least partially within the spindle tube and rotationally engaged therewith such that a rotor axis is oriented substantially parallel to the spindle axis. The apparatus described herein can also include a truss system extending radially from the rotor and a blade assembly movably connected to the truss system and adapted for radially-spaced rotation about the spindle and rotor axes. As described more fully below, the truss system functions in part to permit rotation of the blade assembly while increasing the swept area of the turbine and thus the resultant energy capture.

The present invention also includes a method of shaping an extended airfoil blade. The method described herein can include the steps of placing the blade onto a four-point bending device in an initial position and applying a force to the blade thereby causing deflection of the blade to a predetermined position between a central pair of load points of the four-point bending device. The method described herein can also include the steps of releasing the force and placing the blade onto the four-point bending device in a second position distinct from the initial position. The method described herein can be performed manually, or with the assistance of various equipment such as a bending device described herein which uses the principle of the four point loaded beam.

Many other aspects, features and advantages of the present invention are described in detail below with reference to the following figures.

### BRIEF DESCRIPTION OF THE FIGURES

FIG. 1A is a vertical cross-sectional view and FIG. 1B is a top plan view of a vertical axis wind turbine apparatus in accordance with a preferred embodiment of the present invention.

FIG. 2 is a vertical cross-sectional view of a spindle tube portion of the exemplary apparatus shown in FIG. 1A in accordance with a preferred embodiment of the present invention.

FIG. 3 is an enlarged vertical cross-sectional view of a spindle tube portion of the exemplary apparatus shown in FIGS. 1A and 2 in accordance with a preferred embodiment of the present invention.

FIG. 4A is a side elevation view of a truss system, FIG. 4B is a cross-sectional view of an airfoil, FIG. 4C is a top plan view of a truss-blade connector, and FIG. 4D is a plan view of a blade connector, all usable in a preferred embodiment of the apparatus shown in FIG. 1.

FIG. 5 is a vertical cross-sectional view of a lightning conductor according to one embodiment of the apparatus of the present invention.

FIG. 6 is a vertical cross-sectional view of a lightning conductor according to another embodiment of the apparatus of the present invention.

FIG. 7 is a schematic representation of a four point loaded rigid beam for use in one preferred embodiment of the apparatus and/or method of the present invention.

FIG. 8 a schematic representation of the bending moment distribution for a rigid beam for use in one preferred embodiment of the apparatus and/or method of the present invention.

FIGS. 9A and 9B are front and side elevation views of a loading frame for use in one preferred embodiment of the apparatus and/or method of the present invention.

FIGS. 10A and 10B are perspective views of a counterweight device for use in one preferred embodiment of the apparatus and/or method of the present invention.

### DETAILED DESCRIPTION OF THE PREFERRED EMBODIMENTS

The following description of the preferred embodiments is provided to enable any person skilled in the art to make or use the present invention. Various modifications to these embodiments will be readily apparent to those skilled in the art, and the generic principles defined herein may be applied to other embodiments without departing from the spirit or scope of the invention as set forth in the appended claims.

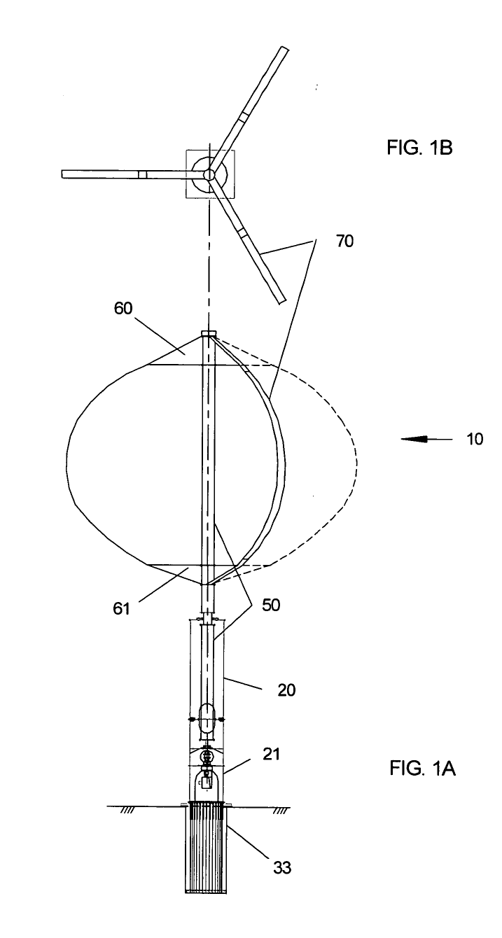

As shown in FIGS. 1A, 1B, 2, 3, and 4A-4D, in a preferred embodiment, the present invention includes vertical axis wind turbine apparatus 10 including a spindle tube 20 connectable to a permanent foundation 33 such that a spindle axis is oriented substantially orthogonal to a surface upon which it is placed. In most cases, the spindle axis will be oriented orthogonal to the ground, thereby extending vertically or substantially vertically from the ground. The apparatus 10 of the preferred embodiment also includes a rotor tube 50 disposed at least partially within the spindle tube 20 and rotationally engaged therewith such that a rotor axis is oriented substantially parallel to the spindle axis. The apparatus 10 of the preferred embodiment can also include a truss assembly extending radially from the rotor 50 and a blade assembly 70 movably connected to the upper and lower truss assemblies 60, 61 and adapted for rotation about the spindle axis and the rotor axis. As described more fully below, the truss assemblies 60, 61 function in part to position and support the blades of the blade assembly 70 while increasing the swept area of the turbine and thus the resultant energy capture.

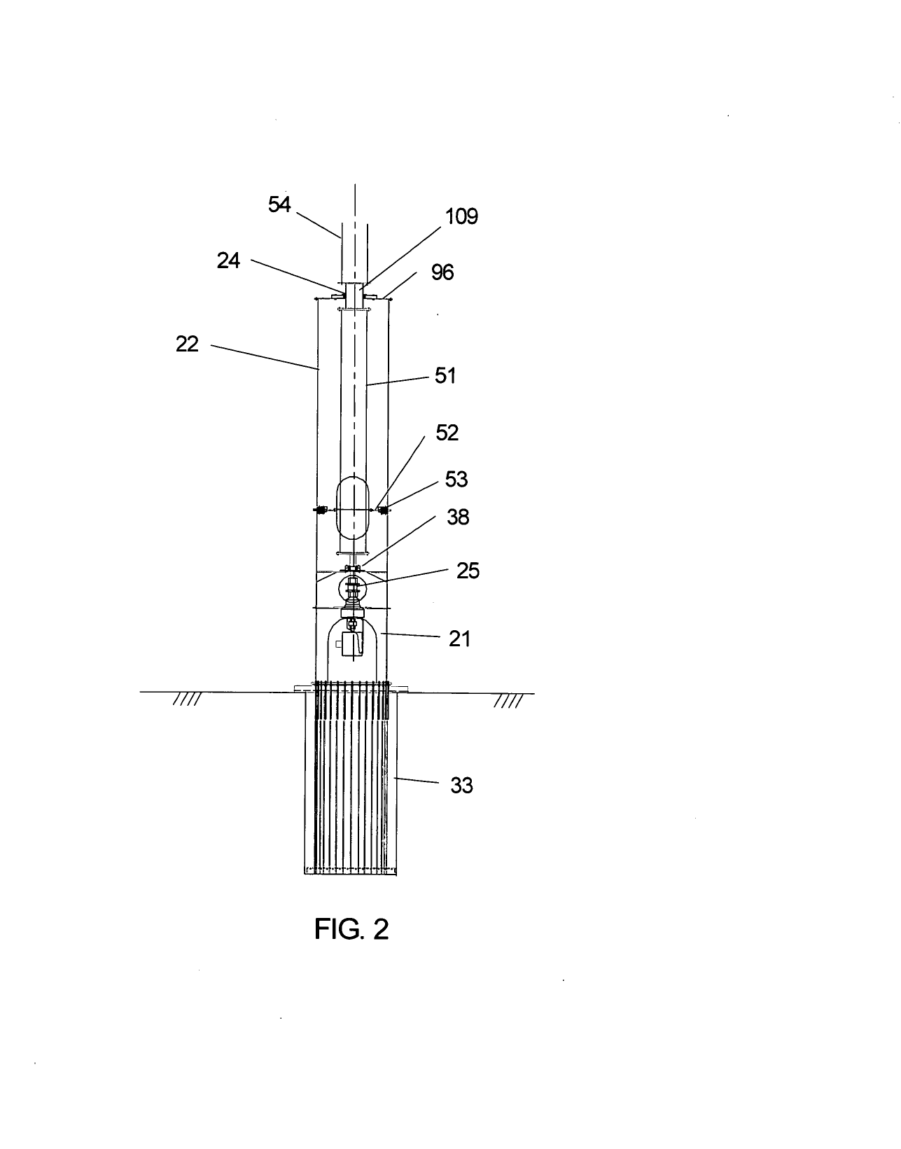

As shown in FIG. 1, when erected, the spindle tube 20 is attached to a foundation 33, which can include for example attaching the spindle tube 20 to one or more concrete foundation studs as described below or embedding the spindle tube base 21 directly and deeply into a mass of concrete. The rotor 50, which has smaller diameter than the spindle tube 20, is constructed of a plurality of circular or polygonal cross-sectional, metal or composite sections that may be tapered. When assembled, the rotor 50 is partially surrounded by the spindle tube 20. As shown in FIG. 2, one or more bearing assemblies 24, 38 serve to rotationally support the rotor 50 and hold it in proper alignment relative to the spindle tube 20.

The apparatus 10 of the preferred embodiment is formed with a large diameter to minimize bending loads of spindle base 21; base 21 comprises the lower portion of the spindle tube 20. In one variation of the apparatus 10 of the preferred embodiment, the spindle base 21 provides a powerhouse, described more fully below.

As shown in FIGS. 1 through 3, the spindle tube 20 can be a hollow, vertically oriented tube comprising the base tube section 21 and an upper spindle tube section 22 mounted on, and connected to, section 21 by appropriate means (e.g., welded or bolted). It will be understood that tube 20 may be constructed of one or more sections. The spindle tube 20 can be of uniform diameter or tapered; the tube 20 material may comprise metals, composite materials or any combination or variation thereof. The spindle tube 20 of the preferred embodiment is not guyed and the vertical thrust and wind-generated overturning moments are fully supported by the spindle and foundation, the vertical load being primarily resisted by thrust bearing 38. In addition, the top of the upper spindle tube 22 is capped with a spindle cap plate 96 that provides a mounting platform for the rotor upper bearing assembly 24.

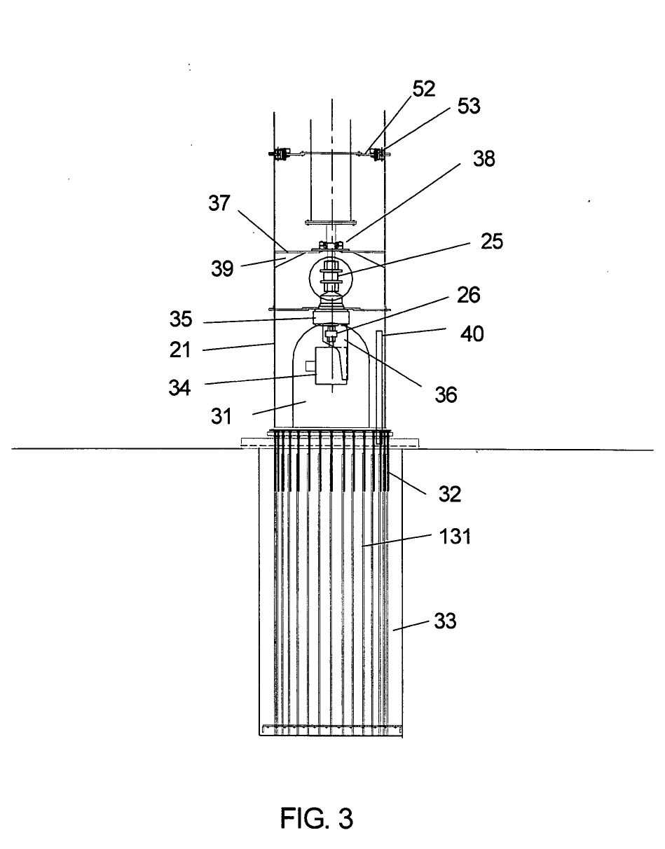

As shown in FIG. 3, the spindle base 21 can be a hollow, vertically oriented tube having a cylindrical or polygonal cross-section and fabricated from individual tubular components. In this particular embodiment the spindle base tube 21 includes one or more access ports or doors 31. The port 31 can have an arch shape or other shape optimized to reduce stress concentrations in the spindle base tube 21 walls.

As noted above, the junction of the spindle tube 20 and the foundation 33 substantially eliminates the need for guy wires to stabilize the apparatus 10 of the preferred embodiment. The spindle base 21 can be bolted or welded to a plurality of circumferentially spaced studs 32 that are embedded into a concrete foundation 33. In one variation of the spindle base 21, a base plate be welded or bolted to the lower end of the spindle base flange in order to cover the end of the spindle base 21. The base plate provides a floor for the spindle base 21 that may be used as a support platform for components, such as a generator, within the powerhouse.

Alternatively, a generator 34 can be hung from the gearbox 35 on the lower end of the rotor 50 using a scoop or C-face mount 36, in which case the base plate is not necessary. A thrust bearing support plate 37 can be reinforced with circumferentially spaced vertical gussets 39, provides a support for the rotor thrust bearing assembly 38 and bears the weight of the rotor 50 and airfoil assembly 70. The thrust bearing support plate 37 can be welded or bolted to the interior of the spindle base tube 21. In another variation of the spindle base 21, a vibration transducer mount 40 can be disposed inside or outside the spindle base tube 21. The vibration transducer mount 40 provides support for a transducer (not shown) that measures spindle wall vibration relative to the vibration transducer mount 40. The vibration transducer can either be of an active or limiting/proximity type.

The apparatus 10 of the preferred embodiment can also include a ladder structure (not shown) that is bolted, riveted or welded to the spindle tube 20 such that a continuous ladder extends from the ground level to the spindle cap plate 96 when the spindle tube sections 21, 22 have been assembled. A similar ladder structure can be bolted, riveted or welded to the interior of the upper spindle tube 22 to provide maintenance access to the upper bearing assembly 24.

As briefly described above, the spindle base 21 can be bolted to one or more threaded studs 32, or welded to studs 32 that are embedded in the concrete and attached by welding or wire ties to one or more foundation reinforcing bars that make up a reinforcing cage 131. The cage 131 has upper and lower annular rings to which the multiple vertical, circumferentially spaced reinforcing bars are attached. In place of separate studs 32, the upper ends of the reinforcing bars of cage 131 may be threaded and bolted directly to spindle base 21. If separate threaded studs 32 are used, they must be attached to the reinforcing bars with a sufficient overlap to fully transmit the tensile and compressive forces to the reinforcing cage 131.

As shown in FIGS. 1, 2, 5 and 6, the rotor 50 includes an upper rotor tube 54 and a lower rotor tube 51 joined by rotor stub 109, having a machined outer surface seated in the upper bearing assembly 24. The lower rotor tube 51 is preferably disposed concentrically within the spindle tube 20 such that the rotor axis is substantially coaxial with the spindle axis. The lower rotor tube 51 can be a hollow, vertical, tube consisting of one or more sections connected together by appropriate means such as welding or bolting. The tube 51 may have a circular or polygonal cross-section with a uniform or variable diameter. The lower rotor tube 51 can be fabricated of metal, composite materials or any suitable combination thereof. In one exemplary embodiment, the lower rotor tube 51 is supported laterally by an upper bearing assembly 24 adjacent to the spindle cap plate 96 and the thrust bearing 38 attached to the thrust bearing support plate 37. The thrust bearing 38 supports the weight of the rotor tube 50 and blade assembly 70. Alternatively, a plurality of bearings can be used along the length of the spindle tube 20 to rotationally support the rotor tube 50. The upper bearing 24 may be of the roller or ball bearing type or alternatively, a split sleeve or journal bearing may be used. In the embodiment shown, a single cylindrical section is used for the lower rotor tube 51. A brake disc 52 may be attached to the lower rotor tube 51 by means of a flange. One or more brake calipers 53 can be mounted on the interior wall of the spindle tube 20 and adapted to engage with the brake disc 52 in order to stop and/or slow the rotation of the rotor 50. Alternatively, a drum brake system that encircles a portion of the lower rotor tube 51 may be utilized to stop and/or slow the rotation of the rotor 50.

As shown in FIG. 2, the rotor stub 109 that serves as a transition section for the upper and lower rotor tube sections may be a hollow, vertical, cylindrical tube. The rotor stub 109 can be fabricated from metal, composite materials, or any combination thereof and may be attached to the upper rotor tube 54 and the lower rotor tube 51 by welding, bolting, or other suitable means.

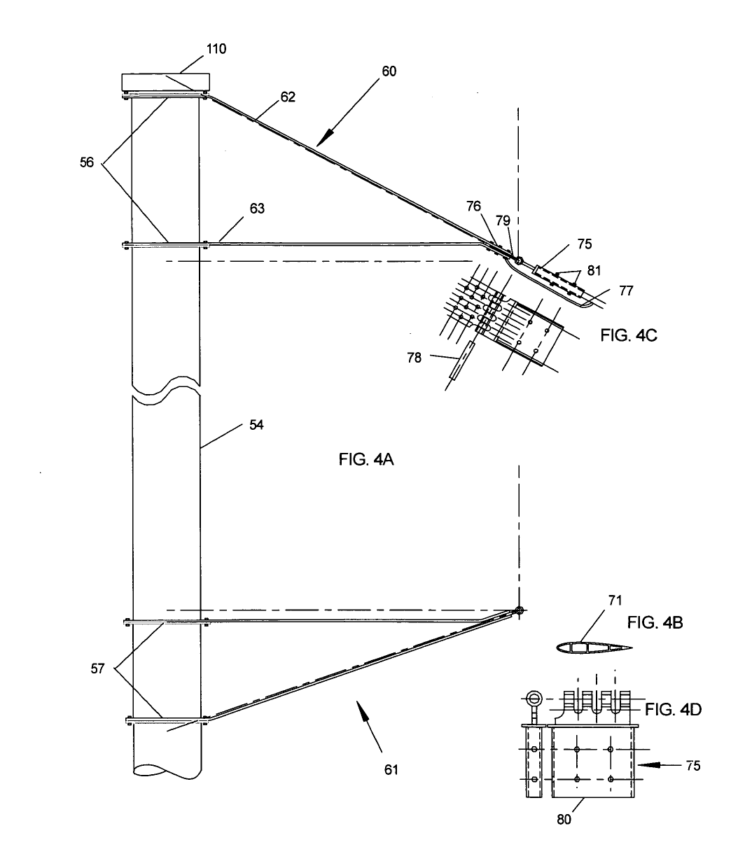

In the embodiment shown in FIG. 4, a single cylindrical section is used for the upper rotor tube 54. The upper rotor tube 54 can include upper and lower attachment flanges 56, 57 for the upper 60 and lower 61 truss assemblies that can be bolted or welded to the rotor tube flanges 56, 57. As noted in greater detail below, the truss assemblies 60, 61 are adapted to support the blade assembly 70. Power from the wind is transmitted to the rotor 50 by means of blade assembly 70 attached to the top and bottom of the upper rotor tube 54 through the truss assemblies. The rotor 50 rotational energy is transmitted through a shaft coupling 25 to the motor-generator 34. In one variation of the preferred embodiment, the apparatus 10 can also include a gearbox 35 as well as a gearbox coupling 26 for ensuring proper power transmission between the rotor 50 and the motor-generator 34.

The blade assembly 70 can include one or more aerodynamic blades fabricated from metal, wood, or composite materials. The one or more blades can have an airfoil cross-section 71 as shown in FIG. 4 and have a curved troposkein shape as shown in FIG. 1. It is desirable to have an airfoil section of the blade 71 that is completely symmetrical. The desirability of a symmetrical airfoil will be appreciated from the fact that during each rotation of the rotor 50, each blade 71 generates lift twice as it passes across the wind direction in both the upwind and downwind regions of its circular path. A vector component of this lift contributes to the generated torque on the rotor 50. A nonsymmetrical airfoil shape will produce a different amount of lift and differential torque on one half of the circular cycle compared to the other thus creating an unbalanced load on rotor tube 50. One airfoil section that has been found suitable for the embodiment shown of the present invention has a shape defined as NACA 0015. Other symmetrical shapes may also be used. The airfoil shaped blades, 71 are bolted, welded, or adhesive bonded to a blade connector assembly (described below) attached to the upper rotor tube 54 through truss assemblies 60, 61 that extend radially outward from the upper rotor tube 54. The embodiment shown utilizes radial truss assemblies 60, 61 that position the blades 71 away from the rotor tube so as to increase the swept area of the turbine and thus the resultant energy capture. Unlike some previous VAWT designs the swept area is not limited by the presence of supporting guy cables or structures.

As shown in FIG. 4, the truss assemblies 60, 61 are constructed of flat plates or box beam members and are connected to the upper rotor tube 54 at the upper and lower rotor flanges 56, 57 on the upper rotor tube 54. Metal or composite materials may be used in the fabrication of the truss assemblies 60, 61. In the example embodiment shown in FIG. 4, the upper truss assembly 60 includes a pair of structural members 62, 63 that are bolted or welded to the rotor flanges 56. The structural members 62, 63 extend radially outward from the rotor tube and serve as an attachment location for the blade assembly 70. The lower truss assembly 61 can have a similar configuration as the upper truss assembly 60. The structural members 62, 63 can have an airfoil shape profile either when fabricated or by adding appropriately shaped cover plates prior to operation.

As shown in FIGS. 1 and 4, the blade assembly 70 can be attached to the upper and lower truss assemblies 60, 61. The apparatus 10 of the preferred embodiment can utilize two or more blade systems to generate power. In the embodiment shown in FIG. 1, the apparatus 10 is a three bladed system that tends to smooth out some of the generated rotor torque ripple as compared to a two bladed system. Each curved blade consists of one or more metal, wood, or composite airfoil-shaped sections 71. In one exemplary embodiment a one piece curved blade section is utilized to form the full blade. In another exemplary embodiment, the blade curvature conforms to that of a troposkein or swinging rope shape that is specific to the geometry and rotational speed of the apparatus 10. In-plane blade bending stresses are essentially eliminated for blades that take on the appropriate troposkein shape and the loads within the blades become primarily tensile at operating speed.

As shown in FIG. 4, blade to truss-blade connectors 75, 76 provide a movable connection such as a hinged or similar connection that serve to transfer bending and axial loads from the blade 71 to the truss assemblies 60, 61 while in operation and when at rest. In addition, the truss-blade connectors 75, 76 must be resistant to fatigue and fretting and also to be able to minimize rotational and gravity induced bending moments. Furthermore, at least the truss-blade connector 75 can provide a metallic pathway 77 for electric current in case the blade 71 sustains a lightning strike. As shown in FIG. 4, hinge pin 78 interconnects truss connector 75 and blade connector 76 thus bending moments in the plane of the blade at the movable joint are essentially eliminated. The truss connector 76 has integral or welded hinge pin openings on hinge plate 79. The blade connector 75 also has hinge pin loops welded to a hollow box structure 80. The end of blade 71 can be inserted into the hollow box 80 and permanently fixed to the connector by bonding, riveting, welding or by bolts 81 that pass through suitable openings in connector box 80 and hinge plate 79. The bolts 81 also aid in transmitting lightning currents to the rotor 50. The hollow box 80 can be fabricated to approximate an airfoil shape to reduce aerodynamic drag.

As noted above, the rotor 50 can be supported by upper and lower rotor bearings 24, 38 which counteract the vertical thrust caused by the weight of the rotor 50 and blade assembly 70 and also resists the overturning moment caused by the wind. The lower or main thrust bearing 38 primarily resists vertical thrust loads and is attached (bolted or welded) to a support plate 37 in the spindle base 21. Lift forces acting on the aerodynamic blades generate a torque on the rotor 50. Rotor 50 is connected to a gearbox speed increaser 35 and then to generator 34.

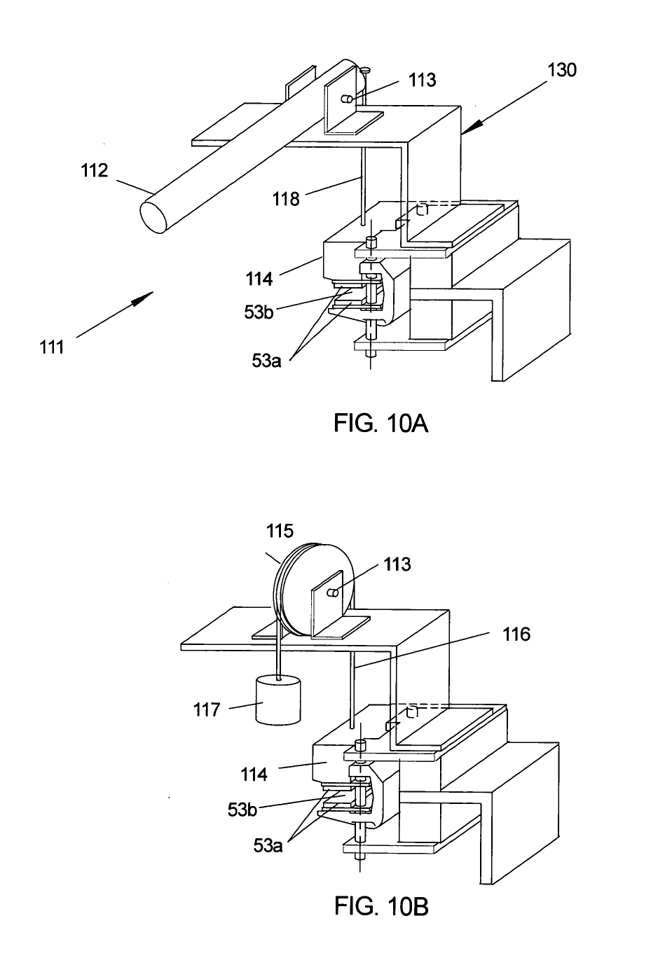

Suitable brake disks and calipers 52, 53 can be of the floating or fixed type. Referring to FIGS. 10A and 10B, floating calipers 114 can ride up or down to accommodate vertical run out variations in the brake disk 52. In this case the weight of the brake caliper 114 can be balanced by a counterweight system 111 consisting of a balance beam 112 on a brake support bracket 130. The counterweight system 111 prevents the caliper 114 from resting with its full weight on the brake disc (not shown) when operational thus reducing wear of the brake pads 53a and a constant drag on the rotor rotation by maintaining a suitable break pad gap 53b. As shown in FIG. 10A, a heavy beam 112 constructed of a dense material is pivoted on an axis 113 so that the weight of the longer portion of the beam counterbalances the caliper 114 weight. The beam 112 is connected to the caliper 114 through a connecting rod 118, although other suitable connecting means may be employed. FIG. 10B illustrates an alternative brake pad system including a pulley 115 mounted on an axis 113 and cable 116 that utilizes a vertically suspended counterweight 117 for balancing the caliper weight 114. In any type of the braking system employed by the apparatus 10 described herein, a fail safe system can be employed wherein loss of actuating power (electrical, pneumatic or hydraulic) causes the immediate application of the brakes thus bringing the rotor and blade assembly of the apparatus 10 to rest.

One means to vary the resonant frequencies of the apparatus 10 after erection is to add a weight 110 to the top of the upper rotor tube 54. This can be accomplished by attaching a pre-fabricated weight 110 made of metal, concrete or other appropriate dense material to the top cap plate bolts.

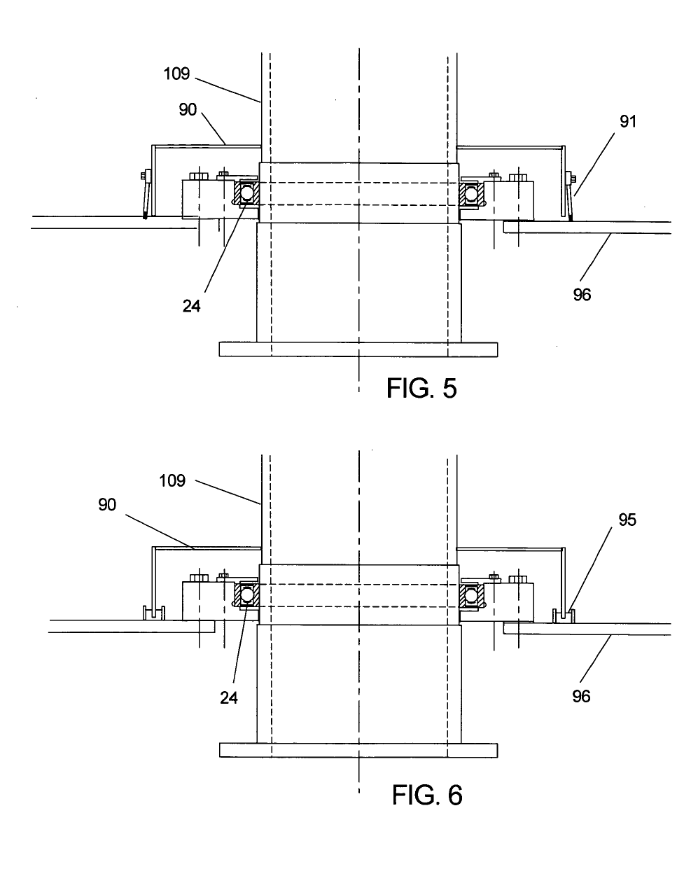

The apparatus 10 described herein can also be configured to sustain lightning strikes without causing damage to the bearings and other drive train components. In one alternative as shown in FIG. 5, the spindle tube 20 can provide the pathway for lightning caused current surges to be conducted safely to ground through a buried conductor ring (not shown) that surrounds the apparatus 10. Lightning strikes to the blade assembly 70 or truss assemblies 60, 61 can be directed through the rotor tube 50 to the upper spindle tube 22 at the bearing 24 by means of a rotatable metal weather cap 90 with attached brush conductors 91. An electrical conducting pathway between the metal airfoils and struts is accomplished through the blade-truss connectors 75, 76 and additional conducting cable 77 that bridges the hinged connection as shown in FIG. 4. At the bearing 24, brush conductors 91 bleed the current pulse away from the bearing 24 directly into the top spindle cap plate 96 of the spindle tube 20 for transmission to ground. Alternatively, as shown in FIG. 6, the lower edge of the metal weather cap 90 may be immersed in an annular bath of a conducting fluid 95, such as mercury, in electrical contact with the spindle cap plate 96. The conducting bath can be positioned around the upper bearing 24 or in any other suitable location for ensuring electrical conduction between the rotor tube stub section 109 and the spindle tube 20.

One problem with older VAWT apparatus is that the blades must be rotated from the rest position under power in order to move the blade airfoil sections at a velocity sufficient to create lift that produces the torque of the rotor assembly. This problem is solved in one embodiment of the apparatus 10 that includes a motor-generator 34 that functions to convert rotational energy into electrical energy in a generation mode and to convert electrical energy into rotational energy in a motor mode. The rotor is rotated from a rest position by operation of the motor generator 34 up to a speed at which the blades develop sufficient wind generated torque. The motor mode may then be terminated by disconnecting the motor-generator 34 from the electrical grid allowing the rotor 50 to spin freely. When synchronous speed is achieved, the motor-generator 34 is switched to operate in a generator mode in which the motor-generator 34 is reconnected to the electrical grid so as to generate and transmit electrical power. There are a number of alternative power train arrangements that can also be utilized. For example a direct drive generator may be used that eliminates the need for the gearbox 35 to increase the shaft speed. Another alternative is a drive train wherein multiple motor-generators are mounted in series.

In one example embodiment of the apparatus of the present invention that has been constructed and experimentally tested in Clines Corners, N.Mex., the blades are designed to rotate at a rotor speed of approximately 41.4 rpm. The gearbox 35 has an input-output ratio of 1:29 to thereby rotate the generator at approximately 1,200 rpm. The speed of the blades, the gearbox input-output ratio, and the generator speed is chosen for the particular application and it will be understood by those of ordinary skill in the art that other rotational speeds and gearbox ratios may be employed. In the prototype VAWT it has been found desirable to rotate the rotor assembly from rest up to a speed of approximately 33 rpm of the rotor 50 at which point the motor is disconnected from the electrical grid and sufficient lift has been created so that the rotor speed will continue to increase slowly up to the operational speed of 41.4 rpm (generator speed 1200 rpm). As is typical in dynamic systems, there is in the prototype a resonant frequency between the rest and lift rpm that is desirably avoided for more than a brief period of time and consequently the motor-driven rotational speed of the rotor from rest through 33 rpm of the rotor 50 is not constant.

The example apparatus 10 has been designed so as to operate at wind speed of at least 13 mph. When the existing environmental conditions produce a time averaged wind of such velocity, as is measured by a standard wind anemometer which is electrically connected to the motor-generator 34, an automatic on-off switch signals the motor-generator 34 to spin the rotor 50 without the requirement of an operator. In the example apparatus 10, there is no maximum speed control because as the rotor 50 begins to increase beyond 41.4 rpm due to increased wind speed the motor-generator 34 will simply generate additional electricity so long as a load in the electrical grid exists. The increasing electrical load prevents the rotor speed from increasing to a rotational speed that may be damaging to the apparatus.

The apparatus 10 can also include various other manual and automatic control system features in order to adapt to the particular conditions in which it is operated. For example, if there is a possibility that the electrical grid is not available and cannot receive additional power from apparatus 10, a control system 41 can shut down the operation of the apparatus 10 through the use of the brake disc and calipers 52, 53. Similarly, when the rotor 50 is spinning and the wind speed drops such that there is insufficient lift to maintain rotor speed above a set minimum it is not generally desirable from a maintenance point of view to allow the rotor to free wheel and thus the brake 52, 53 can be applied and the system stopped until the wind speed has increased to the selected operational start-up level. The application of braking at this rotational level also prevents the rotor 50 from approaching a low rotation structural resonance condition. The control system can include a controller such as a general computer or any suitable combination of hardware, software and/or firmware connected to the motor-generator 34 for controlling the motor mode and the generator mode. The control system can be integral to the motor-generator 34 or function as a separate modular unit disposed inside or outside the spindle tube 20.

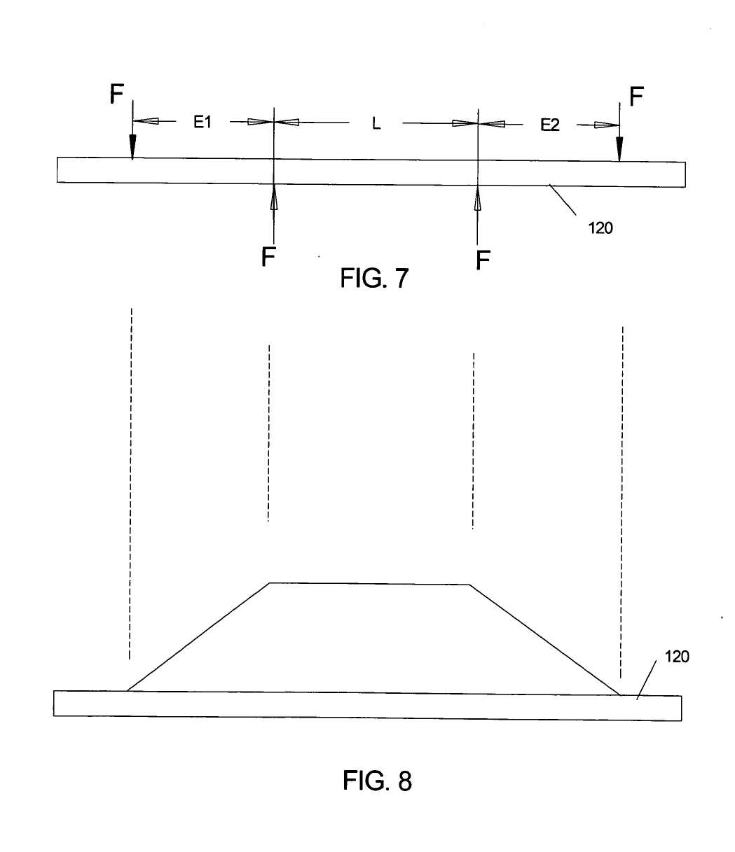

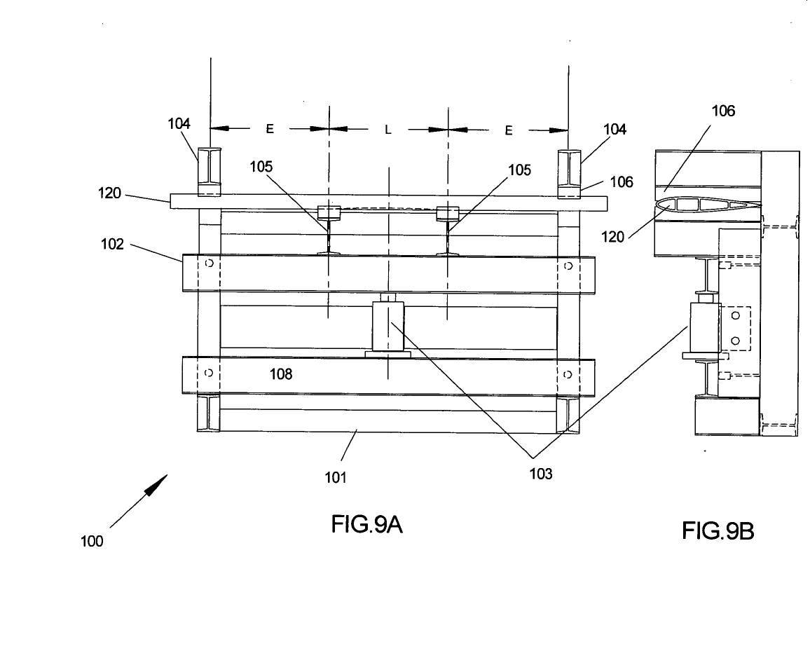

With reference to FIGS. 7 and 8, the present invention also includes a method of shaping an elongated, narrow airfoil blade. The method of the preferred embodiment can include the steps of placing the blade onto a four-point bending device in an initial position and applying a force to the blade thereby causing deflection of the blade to a predetermined position between a central pair of load points of the four-point bending device. The method of the preferred embodiment can also include the steps of releasing the force and placing the blade onto the four-point bending device in a second position distinct from the initial position. The method of the preferred embodiment can be performed manually, or with the assistance of various equipment such as a bending device 100 depicted in FIG. 9 which uses the principle of the four point loaded beam.

As shown in FIGS. 7 and 8, for a rigid, uniform beam 120, at rest, symmetrically loaded at four points, the bending moment generated along the beam 120 can be described by three linear sections E1, E2 and L. For E1=E2=E the bending moment in the middle section of the beam 120 is linear, constant in magnitude, and is the maximum bending moment experienced by the beam, i.e. FE1 or FE2 where E1=E2=E for the beam 120. For a moderately flexible beam 120 the constant central bending moment causes uniform bending in the beam 120 with a constant curvature. Repeated application of the bending process along the beam can be used to approximate a variety of profiles such as, for example, a troposkein profile for an airfoil blade.

FIG. 9 depicts a preferred embodiment of a bending device 100 having of a rigid load frame 101, a movable loading beam 102, and loading jack 103. The rigid loading frame 101 provides static support for two load points 104 of the four load points. The remaining two load points 105 reside on the movable loading beam 102. In the embodiment shown the contact loads are distributed through formed load blocks 106 applied to the airfoil 120. The use of forms 106 shaped to the sectional contour of the airfoil chord 120 reduces load concentrations.

The loading jack 103 provides the force necessary to load the airfoil 120. In the embodiment shown a hydraulic jack 103 is used, although other loading devices operated by pneumatic pressure, or electro/mechanical forces can also be used. Jacks that are restricted to specific displacements can also be used. In the embodiment shown a single loading jack 103 is used to load the movable loading beam 102. It is positioned midway between the load points 105 on the movable loading beam 102. The rigid frame 101 and associated cross beam 108 supplies the other required jack support. Other configurations may utilize more than one loading jack 103. In the bending device 100 embodiment shown, the single jack 103 provides a central load to the rigid movable load beam 102. This load is transferred equally to the load points 105 on the movable load beam 102. The airfoil 120 thus sustains a constant bending moment between the load points 105 on the movable load beam 102. If great enough, the constant bending moment will yield the airfoil 120 longitudinal axis and cause a permanent curvature to the airfoil 120 when the load is released. The resulting curvature is measured by relating the central deflection of the beam according to geometrical relationships known to those of ordinary skill in the art between the curvature, section length, and permanent deflection characteristics. Once the desired deflection or curvature is achieved, the airfoil extrusion is translated a distance L so that a new portion of the airfoil 120 can be bent to the desired curvature. The deflection and curvature may vary for each section of length L. This procedure is repeated until the entire airfoil extrusion has been formed to the desired shape, such as a troposkein curve for use in a preferred embodiment of the apparatus 10 described herein.

The present invention has been described with reference to its preferred embodiments so as to enable any person skilled in the art to make or use the present invention. However, various modifications to these embodiments will be readily apparent to those skilled in the art, and the generic principles defined herein may be applied to other embodiments without departing from the spirit or scope of the invention as set forth in the following claims.

What is claimed is:

1. A vertical axis wind turbine apparatus comprising:
a spindle tube connectable to a permanent foundation such that a spindle axis is oriented substantially orthogonal to a surface upon which it is placed;
a rotor disposed at least partially within the spindle tube and rotationally engaged therewith such that a rotor axis is oriented substantially parallel to the spindle axis;
a truss system extending radially from the rotor; and
a blade assembly movably connected to the truss system and adapted for rotation about the spindle axis and the rotor axis.

2. The apparatus of claim 1 wherein the blade assembly comprises at least two blades each having an aerodynamic cross section.

3. The apparatus of claim 2, wherein the aerodynamic cross section is substantially symmetrical about a vertical blade axis.

4. The apparatus of claim 3, wherein the aerodynamic cross section comprises an NACA 0015 airfoil.

5. The apparatus of claim 2, wherein the each of the blades is curved along a vertical blade axis according to a predetermined geometry.

6. The apparatus of claim 5, wherein the predetermined geometry is a troposkein.

7. The apparatus of claim 1, wherein the blade assembly is connected to the rotor by a truss assembly substantially radially orthogonal to the rotor axis.

8. The apparatus of claim 1, further comprising a drive train having a motor-generator adapted to convert rotational energy of the rotor into electrical energy.

9. The apparatus of claim 8, wherein the motor-generator is further adapted to convert electrical energy into a rotational energy of the rotor.

10. The apparatus of claim 8, further comprising a controller adapted to control the motor-generator in at least a motor mode and a generator mode.

11. The apparatus of claim 10, wherein the controller is further adapted to control the motor mode for a rotor speed less than a first rotational speed.

12. The apparatus of claim 11, wherein the controller is further adapted to control the generator mode for a rotor speed greater than a second rotational speed.

13. The apparatus of claim 12, wherein the second rotational speed is a synchronous speed, and further wherein the second rotational speed is greater than the first rotational speed.

14. The apparatus of claim 13, wherein the second rotational speed is greater than ten miles per hour.

15. The apparatus of claim 10, further comprising an anemometer connected to the controller and adapted to measure wind speed.

16. The apparatus of claim 10, wherein the drive train further comprises a braking system connected to the controller and adapted to cease rotation of the rotor.

17. The apparatus of claim 16, wherein the controller is adapted to apply the braking system in response to one of an unavailability of external electrical power or an insufficient wind speed.

18. The apparatus of claim 8, further comprising a second motor-generator arranged in series with the motor-generator.

19. A vertical axis wind turbine apparatus consisting of:
a spindle tube connectable to a permanent foundation such that a spindle axis is oriented substantially orthogonal to a surface upon which it is placed;
a rotor disposed at least partially within the spindle tube and rotationally engaged therewith such that a rotor axis is oriented substantially parallel to the spindle axis;
a truss system extending radially from the rotor;
a blade assembly movably connected to the truss system and adapted for rotation about the spindle axis and the rotor axis;
a drive train having a motor-generator adapted to convert a rotational energy of the rotor into electrical energy and to convert electrical energy into a rotational energy of the rotor; and
a controller adapted to control the motor-generator in at least a motor mode and a generator mode.

20. A method of shaping an elongated airfoil blade comprising the steps of:
placing the blade onto a four-point bending device in an initial position;
applying a force to the blade thereby causing deflection of the blade to a predetermined position between a central pair of load points of the four-point bending device;
releasing the force; and
placing the blade onto the four-point bending device in a second position distinct from the initial position.
